(19) United States
(12) Patent Application Publication
(10) Pub. No.: US 2011/0249003 A1
(43) Pub. Date: Oct. 13, 2011

(54) CONFIGURABLE FRAMEWORK FOR RICH DATA VISUALIZATION

(75) Inventor: Marc E. Mercuri, Bothell, WA (US)

(73) Assignee: MICROSOFT CORPORATION, Redmond, WA (US)

(21) Appl. No.: 12/758,818

(22) Filed: Apr. 13, 2010

(51) Int. Cl. G06T 11/20

(52) U.S. Cl. 345/440

(57) ABSTRACT

A data visualization system is described herein that provides a flexible, extensible framework for visualizing analytics data. The system allows new data and data sources to be easily added to a dashboard framework without custom programming. This allows organization members without in-depth technical skills to identify organization data that is relevant to them and to quickly produce visualizations that the system can display as organization data changes. Users can leverage visualizations written by third parties and place the visualizations within analytics pages to use the visualizations to view the user's data. The system maps selected visualizations to existing or automatically generated stored procedures or other data interfaces. The system allows third parties to brand the dashboard and individual visualizations. Thus, the data visualization system empowers non-technical organization users to create visualizations of data applicable to their job function or that of other organization members.

### BACKGROUND

Most large organizations track a variety of data that is stored in a number of first and third party data stores. Most organizations have data in databases related to products manufactured and/or sold by the organization, sales of products or services, accounting data, human resources data about employees, advertising and marketing data, and so forth. Typically, this data is stored in custom data stores associated with a product for managing the data. For example, a sales database may be associated with a sales application, and may even be handled by a third party (e.g., SalesForce.com). Payroll data may be stored in a payroll application managed inside the organization or by a third-party provider (e.g., ADP) with external data stores. An information technology (IT) department may manage each of these data stores and applications to maintain the organization's data and provide backups and other features such as fault tolerance and high availability.

Data is often used in visualizations, such as charts, presentations, or other forms of data reporting used by organizations. An organization may design many custom reports used by management at various layers of the organization. For example, a vice president of sales may review weekly charts describing sales of the organization in one or more regions where the organization sells products or services. Organizations often create dashboards that are typically internal web pages or web applications that allow various organization members to view visualizations and process data in a manner applicable to their respective functions. Often such dashboards are created using third party products in concert with custom software and configuration provided by an internal IT department.

Third-party solutions for creating dashboards typically involve varying levels of custom coding. For example, a dashboard may provide a generic web page that IT personnel can populate by writing custom stored procedures to query data from a database and process the results for display by the dashboard. For each type of page or report that someone in the organization wants to receive, an IT engineer or consultant of the dashboard manufacturer typically provides custom logic to produce the report. Custom programming is expensive and time consuming, such that visualization of an organization's data incurs costs each time a new system that acts as a source of data is added to the organization. Receiving applicable data from these systems can take weeks or months waiting for new development to allow organization members to visualize the data most useful for their function within the organization.

### SUMMARY

A data visualization system is described herein that provides a flexible, extensible framework for visualizing analytics data. The system allows new data and data sources to be easily added to a dashboard framework without custom programming. This allows organization members without in-depth technical skills to identify organization data that is relevant to them and to quickly produce visualizations that the system can display as organization data changes. Users can leverage visualizations written by third parties and place the visualizations within customizable analytics pages to use the visualizations to view the user's data. The system maps selected visualizations to existing or automatically generated stored procedures or other data interfaces so that users of the system can use the system without knowledge of the underlying data architecture. In addition, the system allows third parties to brand the dashboard and individual visualizations. Thus, the data visualization system empowers non-technical organization users to create visualizations of data applicable to their job function or that of other organization members.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the data visualization system, in one embodiment.

FIG. 2 is a flow diagram that illustrates processing of the data visualization system to setup analytics data for visualization, in one embodiment.

FIG. 3 is a flow diagram that illustrates processing of the data visualization system to display a selected analytics page with customizable visualizations, in one embodiment.

FIG. 4 is a display diagram that illustrates an analytics page produced by the data visualization system, in one embodiment.

### DETAILED DESCRIPTION

A data visualization system is described herein that provides a flexible, extensible framework for visualizing analytics data. The system allows new data and data sources to be easily added to a dashboard framework without custom programming. This allows organization members without in-depth technical skills to identify organization data that is relevant to them and to quickly produce visualizations that the system can display as organization data changes. In some embodiments, users can leverage visualizations written by third parties and place the visualizations within analytics pages to use the visualizations to view the user's data. The system maps selected visualizations to existing or automatically generated stored procedures or other data interfaces so that users of the system can use the system without knowledge of the underlying data architecture. In addition, the system allows third parties to brand the dashboard and individual visualizations. For example, a provider of payroll data can provide a visualization branded with the provider's logo to advertise and create user awareness of the vendor that provides the data. In some embodiments, users of the system can identify data and create visualizations using an easy to use web page interface, without any complex coding tools. The users can also produce multiple pages for different purposes and organize the pages into useful user interface paradigms (e.g., tabs, linked pages, and so forth) for the user. In some embodiments, the system includes data access templates (e.g., stored procedure templates) for a variety of common situations of accessing data from an organization's data stores. Thus, the data visualization system empowers non-technical organization users to create visualizations of data applicable to their job function or that of other organization members.

The data visualization system provides a flexible, extensible model for the visualization of analytics data. The system provides a set of visualization controls out of the box, and is designed such that an organization, Independent Software Vendors (ISVs) or Digital Agencies can easily add new visualizations.

In some embodiments, the user interface exposes a list of analytics available to the user (e.g., in a list on the left-hand side of the screen) and the selected analytics page (e.g., displayed in the center of the screen). Each visualization is a visual control populated with data, and the control can provide varying levels of interactivity. Each visualization has a label that is displayed in the upper left and a full-screen button in the upper right corner. Clicking on the full-screen button will enable a transition and enlarge the selected visualization to the size of the analytics page. In the upper right corner, the full screen view has a minimize button. Clicking this button will trigger a transition and return the page to its standard design. Visualizations can also be associated with a brand, and the system will display a branding image near the related visualization.

In some embodiments, the user experience of the data visualization system displays a list of available analytics pages on the left, and defaults to showing the first analytics page in the center of the screen with content for the currently selected subject. Clicking on an analytics page in the list displays the corresponding visualization page, also for the current subject. Each visualization is self-contained and provides interactivity based on what the visualization creator provided. Visualizations can support limiting based on date ranges. If this is supported by one or more visualizations on the page, the user can select, for example, a from date and a to date.

In addition to data integration, the data visualization system is also designed to support the integration of new visualizations. Visualizations are developed as controls and instantiated in the user interface via a provided application-programming interface (API) (e.g., the VisualizationControlFactory in Microsoft.Social.Silverlight.Controls.Analytics).

The data visualization system includes a data access layer (e.g., Microsoft.Social.DataAccess.DLL) that exposes methods related to analytics content, as defined below. For example, in one embodiment the system exposes two methods, GetAvailableAnalyticsPages and GetVisualizationsForAnalyticsPage. GetAvailableAnalyticsPages retrieves information to populate the list of available analytics pages. The method may receive a user identifier for both auditing and enabling visualizations at the user level (helpful for ISV plug-ins). GetVisualizationsForAnalyticsPage retrieves the detail for the visualizations related to a given page. It contains information on the visualizations to be used and the associated data for the visualizations. The system retrieves the visualization for the given subject. An analytics page can include one or more visualizations. The data access layer provides interaction to/from a database or other data store using programmable objects with which visualization designers can interface.

In some embodiments, content for visualizations/visualization layers is provided by calling a stored procedure. Using stored procedures makes it straightforward to create visualizations with data from first party data, other data sources, or a combination of data sources. The stored procedures may adhere to a well-defined format, such as receiving a user identifier, subject identifier, from date, and to date as input, and returning a series of data that includes a label and related values associated with the label for the particular visualization. A visualization that does not use from and to dates can ignore these parameters and return any applicable data.

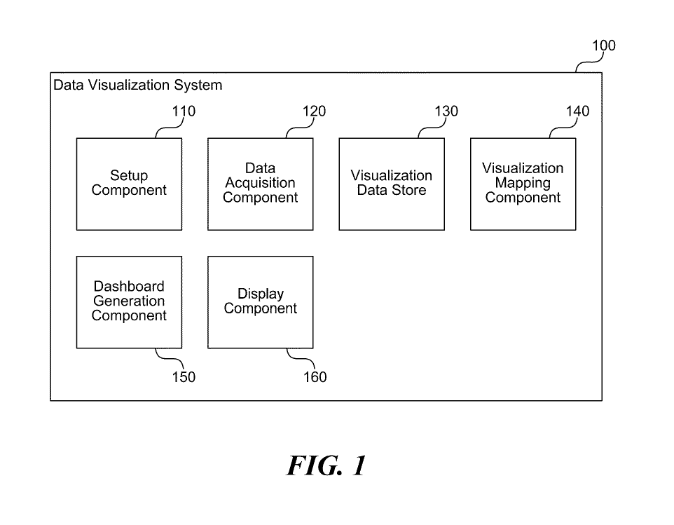

FIG. 1 is a block diagram that illustrates components of the data visualization system, in one embodiment. The system 100 includes a setup component 110, a data acquisition component 120, a visualization data store 130, a visualization mapping component 140, a dashboard generation component 150, and a display component 160. Each of these components is described in further detail herein.

The setup component 110 receives configuration information describing an organization's data sources, in one embodiment. For example, an administrator or user of the system 100 identifies one or more sources of an organization's data. These sources may include databases, file servers, cloud-based storage services, and other sources of the organization's data. The data may include any data related to the organization, such as sales data, advertising data, employee data, customer data, and so forth. The setup component 110 may also automatically identify some data sources, such as by scanning a network to identify available sources. Users may also provide stored procedures or other data acquisition specifications during the setup phase. The specifications provide instructions for retrieving a particular type of data from an identified data source. For example, a stored procedure related to an organization's sales database may extract information from a table of orders, such as the order count, average selling price, and so forth.

The data acquisition component 120 accesses one or more data sources related to an organization to acquire data from the data sources. The data acquisition component 120 may receive input from the user that describes a range of data or particular type of data that the user wants the system 100 to retrieve. The component 120 provides any input received from the user to a stored procedure or other data acquisition specification so that the data source can provide data that satisfies the user's input criteria. For example, the user may want to retrieve data for a particular date range for an organization. The data acquisition component 120 uses various protocols to communicate with data sources of various types. For example, for a cloud-based storage service, the component 120 may communicate using Hypertext Transfer Protocol (HTTP). As another example, for an internal MICROSOFT™ SQL database, the system may use SQL's native protocol to access data.

The visualization data store 130 stores one or more data visualization controls that dynamically bind to data acquired to display the data to a user. Visualizations may be provided by third party control manufacturers, the manufacturer of the system 100, or developed internally within an organization by IT personnel. The visualizations provide a particular way to view data without necessarily knowing the type of data that the visualizations will be used to display. In this way, the process of developing visualizations and finding data are decoupled, so that those developers that are very good at creating useful visualizations can do so, and those that are good at discovering data (e.g., Twitter influencers, data mined from within an organization, and so forth) can do so. The system 100 dynamically re-couples these pieces at runtime so that data identified by a user can be displayed using a visualization selected by the user.

The visualization mapping component 140 provides a mapping between fields of data acquired by the data acquisition component 120 and one or more visualizations stored in the visualization data store 130. The data acquisition component 120 may return data as a generic series in a well-known format, with labels or other information to identify data. The visualizations are designed to adhere to a visualization protocol that is ready to receive the generic series data provided by the acquired data. Thus, the visualization can display whatever type of information that the user can identify, including any ranges of data provided by the user for restricting the data. The visualization mapping component 140 binds fields of the received data with user interface elements of a selected visualization. For example, if the data fields include sales averages for regions to which a company sells products, and the selected visualization is a bar chart, then the system may bind each region's sales average to a bar of the chart.

The dashboard generation component 150 generates a dashboard page including one or more visualizations based on a page selection received from the user. For example, the system may display a list of available analytics pages from which the user can choose, and based on the user's choice the system may display a detailed dashboard page that references a particular set of data and one or more visualizations as described herein. Upon accessing the page, the system invokes the data acquisition component 120 to retrieve the latest data, loads the appropriate visualizations from the visualization data store 130, and invokes the visualization mapping component 140 to map fields of the retrieved data to user interface elements of the visualizations. The system 100 may store analytics pages designed by the user (e.g., using a visual editing interface of the system 100) along with visualizations in the visualization data store 130 so that the user and other users can access the designed pages.

The display component 160 displays the generated dashboard page to the user. For example, the display component 160 may interact with a web browser running on a client computer and accessed by the user to provide the generated dashboard as a web page using Hypertext Markup Language (HTML) or other formats and protocols. The display component 160 may also provide the generated dashboard page through a programmatic API that can provide access to the page to third party tools for further analyzing data provided by the system. For example, the display component 160 may provide a web service API, data feed (e.g., using Really Simple Syndication (RSS)), extensible markup language (XML) export of the output, and so forth.

The computing device on which the data visualization system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

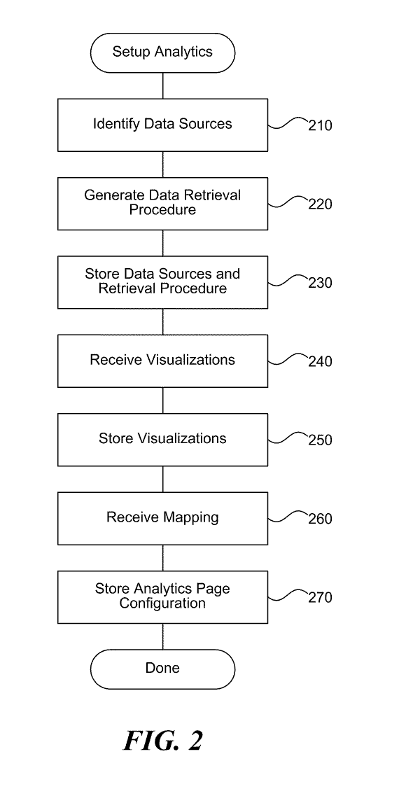

FIG. 2 is a flow diagram that illustrates processing of the data visualization system to setup analytics data for visualization, in one embodiment. Beginning in block 210, the system identifies one or more data sources related to an organization. For example, the system may prompt a user to specify one or more data sources (e.g., by network path and/or type), or the system may automatically identify sources by searching a network. The identified data sources may contain many types of data related to the organization.

Continuing in block 220, the system generates a data retrieval procedure for retrieving data from at least one of the identified data sources. For example, the system may receive a stored procedure for accessing data from a database from a user or administrator, or the system may automatically generate a retrieval procedure. The system may provide a visual tool through which the user can select fields of data (e.g., using checkboxes or other controls), and the system can generate a data retrieval procedure based on the fields selected by the user. Continuing in block 230, the system stores the identified data sources and generated data retrieval procedure in a data store. For example, the system may include a database or other data store for use by the system in which the system stores configuration information, including data sources and data retrieval procedures.

Continuing in block 240, the system receives one or more visualizations for use with the system. For example, a user may install a package of visualization controls created by a third party for use visualizing a variety of data types. Visualizations may include static or interactive charts graphs, textual summaries, presentations, animations, and any other type of visualization. The visualization designer can build visualizations based on a common interface defined by the system without knowing what data to which the visualization may later be bound. Continuing in block 250, the system stores the received visualizations in the data store for later retrieval. For example, the system may store visualizations in the same data store used for other configuration information or a different data store. The visualizations may be provided as software modules (e.g., dynamically linked libraries (DLLs)) or other forms.

Continuing in block 260, the system receives at least one mapping of data sources to visualizations that identifies a source of data that the user selects to retrieve and a visualization with which the user elects to view the retrieved data. For example, the user may build one or more analytics pages that include selected visualizations and data retrieval procedures for providing data to the selected visualizations. Continuing in block 270, the system stores configuration information about one or more analytics pages that include at least one identified data retrieval procedure and at least one data visualization for displaying data retrieved by the data retrieval procedure. For example, a page may identify a stored procedure for retrieving advertising history of an organization (e.g., clicks on an advertisement) and a graphical chart for displaying the advertising data. Using the data visualization system, a user can put together the analytics pages without writing any custom programming logic. After block 270, these steps conclude.

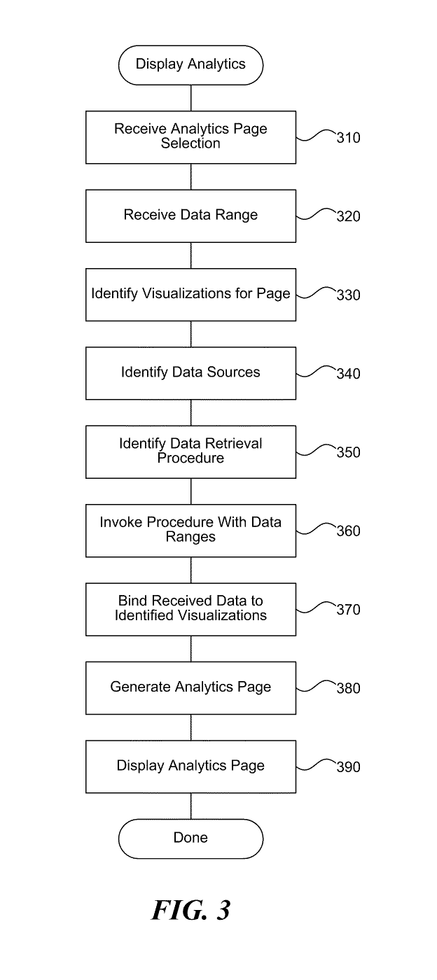

FIG. 3 is a flow diagram that illustrates processing of the data visualization system to display a selected analytics page with customizable visualizations, in one embodiment. Beginning in block 310, the system receives from a user a selection of an analytics page that displays data of an organization through one or more extensible visualizations. For example, the system may initially display a start page to the user that lists available analytics pages from which the user can make a selection. Upon the user clicking on a particular page, the system receives information identifying the selected page and prepares to display the page. Continuing in block 320, the system optionally receives a data range or other information from the user that limits or refines a set of data to be accessed to populate the selected analytics page. For example, the user may specify a date range over which the user wants to analyze data using the system.

Continuing in block 330, the system identifies one or more visualizations associated with the selected analytics page. For example, the system may store a layout of each analytics page in a data store that includes information about the visualizations present on each page. Continuing in block 340, the system identifies one or more data sources to provide data for populating the selected analytics page. For example, the system may store information about the data sources associated with the page along with the visualization information described in the previous example.

Continuing in block 350, the system identifies a data retrieval procedure for retrieving data from the identified data sources. For example, a user or third party may provide a stored procedure for a database or other data retrieval specification that identifies and retrieves a particular type of data from a data store. Continuing in block 360, the system invokes the identified data retrieval procedure and provides any received data range to obtain data from the identified data sources for populating the selected analytics page. For example, if the data retrieval procedure is a database stored procedure, then the system uses a protocol understood by the database to invoke the stored procedure and get data in response.

Continuing in block 370, the system binds data received from the invoked data retrieval procedure to the identified visualizations associated with the selected analytics page. For example, the data retrieval procedure may provide a series of data and one or more labels associated with the data in response and the visualization may receive a series of data with corresponding labels. The system provides the retrieved data to the visualization for display.

Continuing in block 380, the system generates the selected analytics page for display to the user. For example, if the system is provided as a web site, then the system renders the selected analytics page dynamically as an HTML document that can be displayed by a client web browser through which the user accesses the system. Continuing in block 390, the system displays the generated analytics page to the user. For example, the system may display the page through a web browser, mobile application, or custom client application for accessing the system. The displayed page includes the retrieved data displayed through the identified visualizations associated with the selected analytics page. After block 390, these steps conclude.

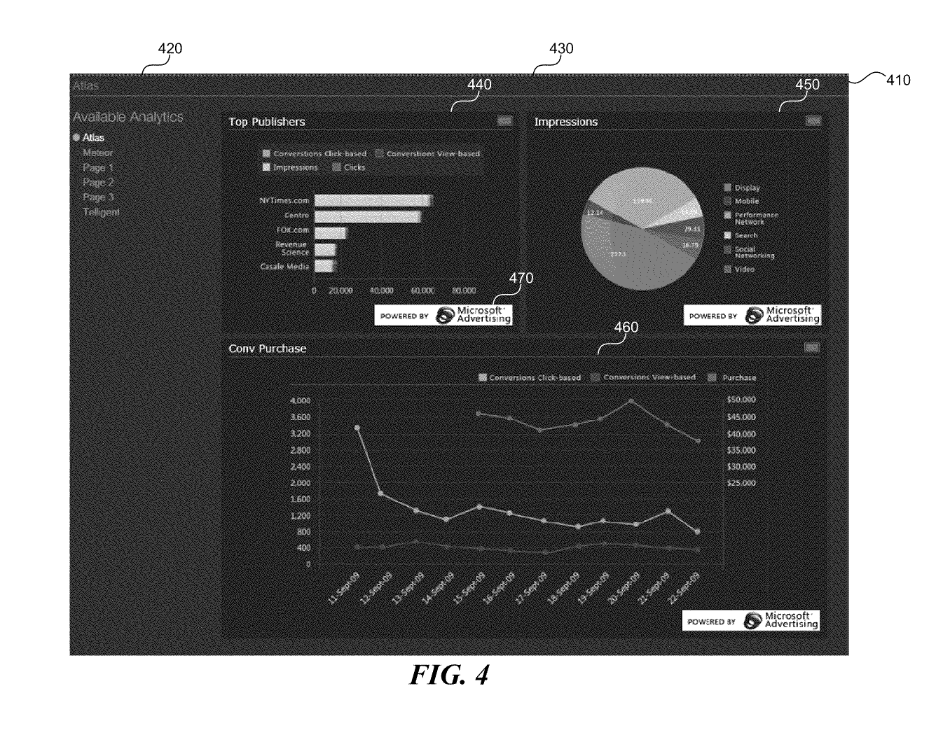

FIG. 4 is a display diagram that illustrates an analytics page produced by the data visualization system, in one embodiment. The analytics page 410 includes a left portion 420 and a right portion 430. The left portion 420 provides a list of available analytics that the user can select to change the display of the right portion 430 to see one or more available types of analytics. In this example, the user has selected the first analytics page entitled Atlas. The right portion 430 includes a first visualization 440, a second visualization 450, and a third visualization 460. Each visualization is branded. For example, the first visualization 440 includes a brand logo 470 that identifies a source/designer of the visualization. Each visualization may display data from a variety of data sources. For example, the first visualization 440 is displaying publishers of an organization's content and how often users are interacting with the content at the publisher's site. This data may come from databases provided by the publishers, data provided by a click tracking provider, or another data source. The second visualization 450 is displaying a pie chart visualization of impression data related to a web site. The third visualization 460 is displaying a line chart of conversions to purchases at an e-commerce web site over a period. The system allows a user to put together these types of pages and visualizations quickly and without programming skills using off-the-shelf visualizations with user selected data sources.

In some embodiments, the data visualization system provides a single visualization with multiple series of data. For example, a particular visualization may indicate through configuration information (e.g., a manifest resource associated with the visualization) that the data source is capable of receiving multiple data series. The user may select multiple data retrieval procedures to provide data to the visualization so that the visualization can visually display the data of both series. For example, one series may represent product sales last year while another series represents product sales this year. The visualization can allow the user to visually compare the sales from each year to identify trends or make decisions.

### Database

Following is an example implementation of a database for supporting the data visualization system. To support analytics, the database contains seven tables—AnalyticsPageMetadata, AnalyticsPageVisualization, Visualization, VisualizationVisualizationLayer, VisualizationLayer, VisualizationLayerMetadata, and VisualizationDataMetadata, described in further detail herein.

| | |
|---|---|
| AnalyticsPageMetadata | AnalyticsPageMetaData provides a |
| | definition of an analytics page. The Label |
| | field found in this table is used in the list |
| | displayed on the left hand side of the |
| | Analyze tab. The SupportsDateRanges |
| | identifies whether or not this particular |
| | page will support filtering by date range. |
| AnalyticsPageVisualization | AnalyticsPageVisualization is a link table |
| | that maps visualizations to an analytics |
| | page, and contains page specific layout |
| | information (top, left, height, width) |
| Visualization | The Visualization table identifies an area |
| | on the screen that presents a |
| | visualization, and includes specific layout |
| | information (top, left, height, and width), |
| | a name, and a label. The name is used to |
| | internally identify the visualization; the |
| | label is used to identify the chart in the |
| | user experience. |
| VisualizationVisualizationLayer | Each visualization can have one or more |
| | layers. A standard visualization (bar chart, |
| | pie graph) will have one layer; advanced |
| | visualizations (multiple visualizations, |
| | multi-series, etc.) can have multiple layers. |
| | The VisualizationVisualizationLayer is a |
| | link table that maps visualization layers to |
| | a visualization. |
| VisualizationLayer | VisualizationLayer is a simple parent |
| | table for VisualizationLayerMetadata, |
| | where the information about a |
| | visualization is stored. |
| VisualizationLayerMetaData | VisualizationLayerMetadata contains |
| | meta-data about a particular visualization |
| | layer. The Visualization page contains a |
| | ControlType field that identifies what type |
| | of control is created to display this |
| | visualization. The Visualization page also |
| | includes a StoredProcedureName field. |
| | This is the name of the stored procedure |
| | that will be executed to retrieve the results |
| | for the user experience. Stored |
| | procedures follow a certain interface. |
| VisualizationDataMetadata | VisualizationDataMetadata identifies the |
| | data returned by the stored procedure |
| | associated with the stored procedure |
| | identified in the |
| | VisualizationLayerMetadata. |

### Data Objects

Following is an example implementation of data objects for visualization designers to access data managed by the data visualization system (e.g., provided in one implementation by the module Microsoft.Social.DataContracts.DLL).

AnalyticsPageMetadata

| Member | Type | Description |
|---|---|---|
| ID | Int | Identifier for the page |
| Name | String | Internal name for the page |
| Label | String | Label for the page to be shown in |
| | | the user experience |
| Description | String | Description of the page (can be |
| | | shown in the user experience) |
| SupportsDateFiltering | Bool | Identifies whether the controls |
| | | support date filtering (user |
| | | experience displays date pickers |
| | | to select To and From datetime if |
| | | true) |
| DateAdded | Datetime | Date this page was added (user |
| | | experience can add a ‘New!’ flag |
| | | for this item if <1 day) |
| LastModified | Datetime | Date this page was last modified |
| | | (user experience can add an |
| | | ‘Updated!’ flag for this item if <1 |
| | | day) |
| IsActive | Bool | Identifies whether or not this page |
| | | is ‘Active’. This flag allows you to |
| | | disable analytics pages, as well as |
| | | configure analytics pages in |
| | | advance of a campaign. |
| ActiveFrom | DateTime | The date/time the analytics page |
| | | was flagged as active |
| ActiveUntil | DateTime | The date/time the analytics page |
| | | was flagged as inactive |

### Visualization

| | | |
|---|---|---|
| ID | Int | Identifier for the |
| | | visualization |
| Name | String | Internal name for the |
| | | visualization |
| Label | String | Label for the visualization |
| | | (to be shown in the user |
| | | experience) |
| Description | String | Description of the |
| | | visualization (to be shown |
| | | in the user experience) |
| Top | Int | Top position of the |
| | | visualization in the user |
| | | experience |
| Left | Int | Left position of the |
| | | visualization in user |
| | | experience |
| Height | Int | Height of the visualization |
| | | in the user experience |
| Width | Int | Width of the visualization |
| | | in the user experience |
| IsActive | Bool | Identifies whether or not |
| | | this visualization is |
| | | ‘Active’. This flag allows |
| | | you to disable analytics |
| | | pages, as well as configure |
| | | analytics pages in advance |
| | | of a campaign. |
| ActiveFrom | DateTime | The date/time the |
| | | visualization was flagged |
| | | as active. |
| ActiveUntil | DateTime | The date/time the |
| | | visualization was flagged |
| | | as inactive |
| DateAdded | DateTime | Date this visualization |
| | | was added |
| LastModified | DateTime | Date this visualization was |
| | | last modified |
| VisualizationLayers | List<VisualizationLayer> | A list of the visualization |
| | | ayers for this visualization |

| | | |
|---|---|---|
| ID | Int | Identifier for a visualization layer |
| Metadata | VisualizationMetadata | Metadata that defines the |
| | | Visualization Layer |
| Data | List<VisualizationData> | A list of VisualizationData objects |
| | | that contain the data for |
| | | visualization layer |
| IsActive | Bool | Identifies whether or not this |
| | | visualization layer is ‘Active’. This |
| | | flag allows you to disable |
| | | visualization layers, as well as |
| | | configure visualization layers in |
| | | advance of a campaign. |
| ActiveFrom | DateTime | The date/time the visualization |
| | | layer was flagged as active |
| ActiveUntil | DateTime | The date/time the visualization |
| | | layer was flagged as inactive |
| DateAdded | DateTime | Date this visualization was added |
| LastModified | DateTime | Date this visualization layer was |
| | | last modified |

| | | |
|---|---|---|
| ID | Int | Identifier for this |
| | | visualization metadata |
| | | definition |
| VisualizationLayerID | Int | Identifier for the parent |
| | | Visualization Layer |
| ControlType | String | Defines the type of control |
| | | e.g., Silverlight) used on |
| | | this layer of the |
| | | visualization |
| StoredProcedureName | String | The name of the stored |
| | | procedure called to return |
| | | the data for the |
| | | visualization |
| XamlStylsheet | String | The name of a XAML |
| | | stylesheet used to style |
| | | the visualization |
| Name | String | The internal name for the |
| | | metadata definition |
| Label | String | The label for the metadata |
| | | definition |
| Description | String | A description of the |
| | | visualization |
| Dimensions | Int | Identifies the number of |
| | | dimensions |
| VisualizationElements | List<VisualizationDataMetadata> | Metadata that identifies the |
| | | fields used in the |
| | | visualization |
| IsActive | Bool | Identifies whether or not |
| | | this visualization is ‘Active’. |
| | | This flag allows you to |
| | | disable visualizations, as |
| | | well as configure |
| | | visualizations in advance |
| | | of a campaign. |
| ActiveFrom | DateTime | The date/time this record |
| | | was flagged as active |
| ActiveUntil | DateTime | The date/time this record |
| | | was flagged as inactive |
| DateAdded | DateTime | Date this record was |
| | | added |
| LastModified | DateTime | Date this record was last |
| | | modified |

| | | |
|---|---|---|
| FieldType | String | Identifies the field type for the |
| | | column, for conversion from |
| | | Object |
| FieldLabel | String | Label of the column returned by |
| | | the stored procedure |
| IsActive | Bool | Identifies whether this record is |
| | | active. Active records are used by |
| | | the user experience; inactive |
| | | records are not. |
| ActiveFrom | DateTime | Date the metadata has been |
| | | active from |
| ActiveUntil | DateTime | Date the metadata was flagged as |
| | | inactive |
| DateAdded | Datetime | Date the metadata was added |
| LastModified | Datetime | Date the metadata was last |
| | | modified |

| | | |
|---|---|---|
| Label | String | Label associated with the |
| | | current line of data (e.g., if the |
| | | visualization was for a list of |
| | | companies, this would be the |
| | | text for the company name) |
| VisualizationElementValues | List<Object> | Data to be used by the |
| | | visualization in a visualization |
| | | layer |

From the foregoing, it will be appreciated that specific embodiments of the data visualization system have been described herein for purposes of illustration, but that various modifications may be made without deviating from the spirit and scope of the invention. Accordingly, the invention is not limited except as by the appended claims.

I/We claim:

1. A computer-implemented method for displaying a selected analytics page with customizable visualizations, the method comprising:
receiving from a user a selection of an analytics page that displays data of an organization through one or more customizable visualizations;
identifying one or more visualizations associated with the selected analytics page;
identifying one or more data sources to provide data for populating the selected analytics page;
identifying a data retrieval procedure for retrieving data from the identified data sources;
invoking the identified data retrieval procedure to obtain data from the identified data sources for populating the selected analytics page;
binding data received from the invoked data retrieval procedure to the identified visualizations associated with the selected analytics page;
generating the selected analytics page for display to the user; and
displaying the generated analytics page to the user,
wherein the preceding steps are performed by at least one processor.

2. The method of claim 1 wherein receiving the selection of the analytics page comprises initially displaying a start page to the user that lists available analytics pages from which the user can make a selection.

3. The method of claim 1 further comprising, after receiving the selection of the analytics page, receiving a data range from the user that limits a set of data to be accessed to populate the selected analytics page.

4. The method of claim 1 wherein identifying one or more visualizations comprises accessing a stored layout of the selected analytics page in a data store that includes information about the visualizations present on each page.

5. The method of claim 1 wherein identifying one or more data sources comprises accessing stored configuration information about the data sources associated with the selected analytics page.

6. The method of claim 1 wherein identifying a data retrieval procedure comprises dynamically generating a data retrieval procedure.

7. The method of claim 1 wherein identifying a data retrieval procedure comprises accessing a stored procedure for a database, wherein the stored procedure was previously specified by the user.

8. The method of claim 1 wherein invoking the identified data retrieval procedure comprises sending a message via a protocol understood by the identified data source and receiving data in response.

9. The method of claim 1 wherein binding data received comprises receiving a series of data in response to invoking the data retrieval procedure and providing the received series to at least one visualization for display.

10. The method of claim 1 wherein generating the selected analytics page comprises rendering the selected analytics page dynamically as an HTML document that can be displayed by a client web browser through which the user accesses the system.

11. The method of claim 1 wherein displaying the generated analytics page comprises providing the displayed visualizations through an application programming interface (API) to a third party software application.

12. A computer system that provides a configurable framework for rich data visualization, the system comprising:
a processor and memory configured to execute software instructions;
a setup component configured to receive configuration information describing one or more data sources associated with an organization;
a data acquisition component configured to access one or more data sources related to the organization to acquire data from the data sources;
a visualization data store configured to store one or more data visualization controls that dynamically bind to data acquired to display the data to a user;
a visualization mapping component configured to provide a mapping between fields of data acquired by the data acquisition component and one or more visualizations stored in the visualization data store;
a dashboard generation component configured to generate a dashboard page including one or more visualizations based on a page selection received from the user; and
a display component configured to display the generated dashboard page to the user.

13. The system of claim 12 wherein the setup component is further configured to receive information identifying one or more data sources managed by a third party outside of the organization.

14. The system of claim 12 wherein the setup component is further configured to automatically identify at least one data source.

15. The system of claim 12 wherein the setup component is further configured to receive a data acquisition specification that specifies steps for retrieving data from a data source.

16. The system of claim 12 wherein the data acquisition component is further configured to receive input from the user that describes a range of data that the user wants the system to retrieve.

17. The system of claim 12 wherein the visualization data store can be further configured to store at least one visualization provided by a third party, wherein the visualization provide a way to view data without knowing the type of data that the visualization will be used to display.

18. The system of claim 12 wherein the visualization mapping component can be further configured to obtain data from the data acquisition component as a generic series in a well-known format and provide the series to a visualization adhering to a visualization protocol that is ready to receive the generic series provided by the acquired data.

19. A computer-readable storage medium comprising instructions for controlling a computer system to setup analytics data for visualization, wherein the instructions, when executed, cause a processor to perform actions comprising:
identifying one or more data sources related to an organization;
generating a data retrieval procedure for retrieving data from at least one of the identified data sources;
storing the identified data sources and generated data retrieval procedure in a data store;
receiving one or more visualizations for use with the system to display data;
storing the received visualizations in the data store for later retrieval;
receiving at least one mapping of data sources to visualizations that identifies a source of data that a user selects to retrieve and a visualization with which the user elects to view the retrieved data; and
storing configuration information about one or more analytics pages that include at least one identified data retrieval procedure and at least one data visualization for displaying data retrieved by the data retrieval procedure.

20. The medium of claim 19 wherein generating the data retrieval procedure comprises receiving a stored procedure for accessing data from a database from a user.
